(19) United States
(12) Patent Application Publication
(10) Pub. No.: US 2007/0133762 A1
(43) Pub. Date: Jun. 14, 2007

(54) Integrated communication device for data, voice and facsimile communications

(75) Inventor: Boris Eugene Berkman, Los Angeles, CA (US)

Correspondence Address: YING CHEN, 255 S. GRAND AVE., # 215, LOS ANGELES, CA, 90012, US

(73) Assignee: UCM Technologies, Inc.

(21) Appl. No.: 11/299,928

(22) Filed: Dec. 12, 2005

(51) Int. Cl. H04M 11/00

(52) U.S. Cl. 379/93.01

(57) ABSTRACT

A phone/Internet messaging appliance device suitable for homes or small offices includes a single external port for connecting to an analog telephone line, a broadband filter/splitter, analog voice/fax modem circuitry, broadband modem circuitry, and a control unit for controlling the operation of the device, all of the above components being integrated in a single housing. The device has a solid-state memory capacity, but does not contain any storage device with moving parts such as a tape or a hard disk. Using the broadband modem circuitry, the device sends received voice and fax messages to designated locations on the external packet-switching network for retrieval by the user. Optionally, the device has a network interface for connecting to external PCs or printers on a LAN to store or print the voice and fax messages locally, in which case the device can also serve as a gateway for the LAN.

### BACKGROUND OF THE INVENTION

1. Field of the Invention

This invention relates to communication devices for homes and small businesses, and more particularly, to a device that combines Digital Subscriber Loop (DSL) Internet connectivity and flexible Public Switched Telephone Network (PSTN) voice and fax message delivery functionalities in a single enclosure.

2. Description of the Related Art

There is a gap between traditional means of communications using PSTN and related messaging devices such as autonomous fax and answering machines on one side, and computer-based communications occurring via packet-switching networks (LAN, WAN/Internet) on the other side.

The solutions known in the art to close this gap usually utilize general purpose computers/servers and/or specialized “voice over IP” equipment, and require multiple separate external connections (one for PSTN, another for packet-switching networks). Such a solution would provide centralized integrated messaging and is suitable for big companies, where its cost (including maintenance) is substantially less than the total cost of a large number of individual solutions for all the employees.

### SUMMARY OF THE INVENTION

However, there are growing numbers of users (both individuals and small companies) who have a high-speed Internet connection (in particular—using DSL modems), but still use conventional fax and answering machines for voice and fax messages. Most of these individuals and small companies don't want to install any extra servers/equipment and don't want to use third party integrated solution services, due to cost and privacy considerations. Also, in most of the cases their answering and fax machines are always “on”, waiting for incoming messages, but there are no computers/servers, which are connected to the Internet all the time (rather, they connect to the Internet on the “as needed” basis). As a result, these users still have many specialized individual devices (answering machine, fax machine, DSL modem), which are not integrated in any way, although they use the same physical PSTN phone line (or lines) for all the communications. Such users can't easily check their voice/fax messages unless they physically come to their home/office. Most of these users would gladly trade those multiple specialized individual devices for a single device that would provide them with the combined functionality (fax plus answering machine plus DSL modem)—especially if this device would allow them to easily check their messages remotely. This invention offers one solution on how such a device can be built and operated.

Accordingly, the present invention is directed to a communication device that substantially obviates one or more of the problems due to limitations and disadvantages of the related art.

An object of the present invention is to provide an integrated, inexpensive solution for communication needs of homes and small businesses.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a communication device which includes a single external port for connecting to an analog telephone line of a circuit-switched network (e.g., PSTN); a broadband splitter circuitry connected to the single external port for separating the broadband and voice-band signals received from the external port and simultaneously outputting broadband signal on a broadband line and voice-band signal on a voice band line; analog voice/fax modem circuitry connected to the broadband splitter circuitry for receiving the voice band signal from the analog telephone line and for digitizing and recording voice and fax messages; broadband modem circuitry connected to the broadband splitter circuitry for providing a high-speed connection to an external packet-switching network via the analog telephone line; memory circuitry for storing digital data (including a non-volatile memory for storing firmware, settings and voice messages received from the analog telephone line); and a control unit for controlling the operation of the communication device, the control unit programmed to automatically deliver both voice and fax messages received by the analog voice/fax modem to a designated location on the external packet-switching network using the broadband modem circuitry, wherein the external port, the broadband splitter, the analog voice/fax modem circuitry, the broadband modem circuitry, the memory circuitry, and the control unit are integrated in a single housing.

The communication device is provided either with a microphone, a speaker and a plurality of control keys, or with a telephone port for connecting to a telephone set.

The communication device may also include a network interface for connecting to a local area network (LAN), wherein the control unit is programmed to transmit data representing voice or fax messages via the network interface to the LAN where it is to be stored or printed by an external device connected to the LAN. In addition, the control unit may be programmed to route data between the network interface and the external packet-switching network, thus connecting devices on the LAN to the external packet-switching network.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a phone/Internet messaging appliance (PIMA) according to embodiments of the present invention.

FIG. 2 illustrates an authentication method according to another embodiment of the present invention.

### DETAILED DESCRIPTION OF THE PREFERRED EMBODIMENTS

A phone/Internet messaging appliance (PIMA) device according to embodiments of the present invention is a device contained in a single housing and suitable for use in homes or small businesses that subscribe to broadband service via a Public Switched Telephone Network (PSTN).

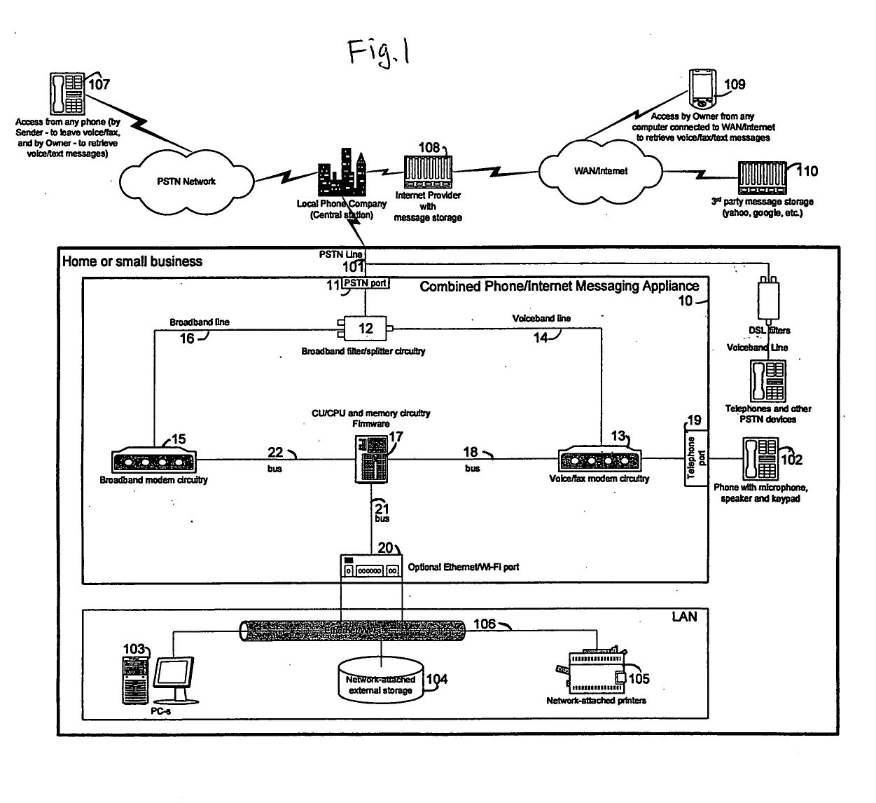

In the first preferred embodiment shown in FIG. 1, the phone/Internet messaging appliance (PIMA) device 10 includes a external port 11 connecting the device to an analog PSTN telephone line 101, broadband filter/splitter circuitry 12 connected to the PSTN port 11, analog voice/fax modem circuitry 13 connected to the broadband filter/splitter circuitry 12 by a voiceband line 14, broadband modem circuitry 15 (e.g. high-speed digital DSL modem) connected to the broadband filter/splitter circuitry 12 by a broadband line 16, and a control unit 17 connected to the voice/fax modem circuitry 13 (preferably by a bus 18) and to the broadband modem circuitry 15 (preferably by a bus 22). The control unit 17, which may be implemented as a CPU with a memory and related control software or firmware, controls the operation of the PIMA device 10. The memory includes a non-volatile memory for storing program firmware, device settings, as well as incoming voice messages received from the analog telephone line. The control unit 17 has a certain amount of memory capacity implemented by some solid-state memory component(s), but the PIMA device does not contain any storage device with moving parts such as a tape or a hard disk. This reduces the size and cost of the device and also increases its reliability.

The broadband modem circuitry 15 provides a high-speed connection to an external packet-switching network via the analog telephone line 101. The voice/fax model circuitry 13 includes circuitry that converts incoming fax signals into digital data for storage; it also digitizes the incoming voice signal for storage. The device 10 is programmed to provide the usual answering machine functions such as picking up a voice call, playing outgoing greetings or other voice prompts, etc. The device 10 may include a microphone, a speaker, and a number of control keys (not shown in FIG. 1) to interface with the user. The control keys are preferably a keypad similar to a regular telephone keypad and generate DTMF (dual-tone-multi-frequency, also known as touch-tone) signals. Alternatively, the PIMA device 10 may include a telephone port 19 for connecting an external telephone set 102 with the voice/fax modem circuitry 13. The receiver (and/or microphone, and speaker) and keypad of the external telephone set 102 can be used to interface with the user.

The PIMA device provides simultaneous access of both analog voice/fax modem circuitry 13 and the broadband modem circuitry 15 to the same analog telephone line 101 via a single external connector (the PSTN port 11). This is accomplished by the broadband filter/splitter circuitry 12 (sometimes referred to as a DSL splitter or a DSL filter, generally referred to as a broadband splitter circuitry in this disclosure), which separates the lower frequency voice/fax signals from the high-frequency network packets carrying binary data using the TCP/IP or UDP protocol.

Optionally, the PIMA device 10 may also include a network interface 20, such as an Ethernet port or switch or a Wi-Fi port, which may be connected to the control unit 17 by a bus 21. The network interface 20 may be used to connect the PIMA device 10 to external devices such as PCs 103, external storage devices 104, printers 105, etc. via an external local area network 106 such as an Ethernet or a Wi-Fi network in the user's home or on the premise of the small business.

Each component described above can be implemented using known technologies. The actual implementation may be hardwired logic or processors controlled by software or firmware. The term “circuitry” used in this disclosure should be broadly understood to include any suitable structures.

In operation, each incoming voice or fax message from PSTN line (left by a “Sender”) is received by the voice/fax modem circuitry 13, and stored as digital data in the semiconductor memory of the control unit. The user can later play back voice messages using the control keys and the speaker of the PIMA device (if provided) or using the external telephone set 102. Alternatively, the user may call the device from a remote telephone 107, and use DTMF signals sent over the analog telephone line (PSTN) to remotely retrieve voice messages recorded in the memory of the PIMA device. For security purposes, password-based authentication (using the same DTMF signals) is preferably required for remote message retrieval.

Additionally, both voice and fax messages, in the form of digital data or voice files, are sent through the broadband modem circuitry 15 (using any standard TCP/IP or UDP protocol) and the PSTN port 11 to one or more designated locations on the external packet-switched network such as one or more remote servers (108, 110), where they are left for later retrieval. For example, the voice and fax messages may be forwarded to the user's email accounts in the form of email attachments. Such files may be stored in the space provided by the user's Internet (or email) service provider. There are also many other available options to store these files using various services, which provide storage (often free of charge) for user data. Examples of providers where messages may be stored include streamload.com, box.net, freedrive.com, yahoo.com, google.com, etc. Once the voice or fax files are stored on the remote servers, the user can retrieve files and play back the message or view the fax using a device 109 (computer, PDA, etc.), connected to the servers (e.g. via the Internet).

The same PIMA device 10 may be utilized to serve multiple users (e.g., different family members or different individuals in a small business) sharing the same home or office, as long as their number is small and the device maintenance/privacy arrangements between these owners are simple. To do this, configurable menus (voice prompted) can be created, and the message destination (the individual user) will have to be chosen by the Sender. To distinguish between different users, the Sender would choose whom the message is intended for and other options from the menus, using DTMF. Also, different ID's and/or passwords are used by different users to authenticate themselves, so only messages intended for a user would be played to him or her.

One way to configure the device for multiple users is by using DTMF codes. For example, the device may be programmed to prompt the user to make selections by DTMF codes and record outgoing greetings. This setup operation is preferably performed locally, by using either the built-in speaker, microphone and control keys or by using the external telephone set 102. The setup operation may also be performed from a remote call, but this is less preferred as it may be less secure. A special “reset” button may be used to return the device settings to the factory defaults.

When the PIMA device 10 includes a network interface 20 connected to external devices via a LAN 106, the device may be configured to store incoming voice or fax messages on the LAN (using as a destination a network-attached storage device 104 or PC 103)—in addition to or instead of delivering to external servers. The device may also be configured to print incoming faxes on a networked printer 105. Thus, in addition to playing back voice messages, retrieving voice messages by a telephone call, and retrieving voice and fax messages from a remote server via the Internet, the user may also retrieve hard copies of fax messages from the printer, as well as accessing voice and fax messages electronically from the storage device 104 via the LAN 106. The last retrieval method has the advantage that the stored messages are available to the “local” user(s) even in the absence of an Internet connection.

In addition, when the PIMA device 10 is connected to a computer 103 via the network interface 20, configuring the device may be done from the computer 103 in addition to or instead of the DTMF-based configuration procedure described above. In this instance, the control unit is programmed to communicate with the computer and software on the computer or the PIMA device 10 allows the user to configure the device 10.

Further, when the PIMA device i0 has a network interface 20 connected to a LAN 106, the device 10 may be programmed to serve as a gateway for the LAN, providing Internet connectivity for the user's home or office. This function is similar to that of a conventional ADSL or SDSL modem device. Control software in the device 10 allows the device to be appropriately configured to provide this function.

A PIMA device according to embodiments of the present invention provides homes and small offices with the combined functionality of fax, answering machine and DSL modem, which is enhanced by the possibility to deliver messages remotely, for a small fraction of the cost of alternative solutions. It can become the only device the owner will ever need to keep “on” all the time in his/her home or office to facilitate various connectivity tasks—both voice/fax and computer-related.

Due to absence of any mechanical/moving parts (such as hard disks, for example), the device is very reliable, durable, and it is easy and cheap to maintain the device.

Many other variations and use cases for the device are possible, in addition to those included in the description. For example, when the PIMA device 10 with a network interface 20 serves as the LAN's gateway to the Internet or a WAN, the device may additionally provide the function of filtering the data it routes between the LAN and the Internet or the WAN. Such a filtering may be done on the packet level (i.e., adding “firewall” functionality), and/or on the higher (“content”) level by adding “content filtering” (e.g., filtering out sensitive information like credit card numbers, when it is sent out unencrypted, or filtering out questionable content arriving into children's computers).

An optional functionality of the PIMA device is providing a remote access to the PIMA device or other devices on the LAN from external computers on the Internet where the remote user can be granted access to the private information that is contained inside the PIMA device or on the LAN. To accomplish this function, the user will have to communicate his authentication information to the PIMA device via the circuit-switched network, as opposed to using DTMF signals.

Any remote access that involves sending data from the input devices of the unknown (and potentially unsafe) systems on the Internet (for example, hitting keyboard keys of unknown computers or even unknown remote phones) may pose a danger to the sensitive information stored on the target PIMA device or other devices on the LAN it is connected to. One example of such a danger is a potential ability of a potential attacker (who controls the remote system) to record keystrokes or DTMF codes, containing the owner's authentication information (e.g. username and/or password). Later the attacker could use this information to gain access to the user's home system by impersonating the owner (that is, simply re-entering the authentication information captured previously).

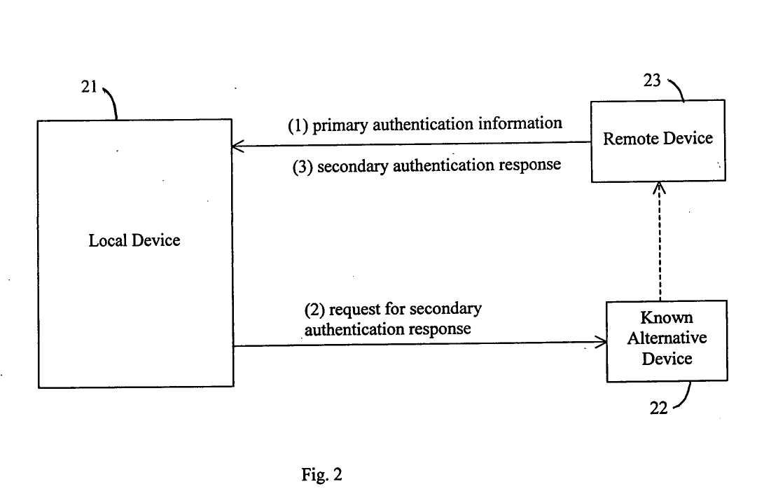

To protect against such an attack, the PIMA device may be programmed to request additional authentication, as shown in FIG. 2. For example, the device may require a secondary (“dynamic”) part of the authentication info to be entered by the remote user after the primary (“static”) authentication info is entered and positively verified by the device. The primary authentication information is typically a user id and a password, and is considered “static” because it is compared to information pre-stored in the device for verification purposes. The secondary authentication information is “dynamic” in that it involves information generated by the device at the time of the attempted access. To accomplish this, the device 21 may be programmed to transmit a request for a dynamically generated “secondary authentication response” via an alternative communication channel to an alternative remote device 22 (i.e. a communication channel and a remote device other than the communication channel and the device used to enter the primary authentication information). The alternative remote device is a “known” device, i.e., one that is known to be personally associated with the authorized user (the user to whom the primary authentication information belongs), such as the user's pager, cell phone, handheld email device, etc. A one-way communication channel is sufficient for this purpose, and the request for a secondary authentication response may be a voice message, pager message, email, a short message sent via an SMS (Short Message Service) system, etc. The request may be an explicit request to enter an expected secondary authentication response, such as “Please enter 4567”. The request may also be a coded message suggestive of the expected secondary authentication response, such as “Please enter 4567” when the expected secondary authentication response is in fact 7654. The latter approach requires prior knowledge on the part of the authorized user as to how to interpret the request. The remote user then enters the expected secondary authentication response from the remove device 23 based on the request received via the alternative device. Only those users who can correctly enter both static (primary) and dynamic (secondary) authentication info will be able to gain access to the device. Moreover, if a situation occurs that the primary authentication data is correct and the secondary authentication incorrect, it shall be interpreted as a breach of security, the user shall be notified about it, and, potentially, remote access for that user has to be revoked, until he has a chance to reconfigure his authentication data locally. This feature will protect against attacks based on capturing user's input on unsafe remote device(s) used as an entrance to the primary channel of communication.

The majority of the features of the PIMA device can be implemented even when the device does not have an external IP address, accessible outside of the Internet Service Provider's (ISP) network. It is especially important, because many home and small business customers who use cable or ADSL Internet connections don't have such an external IP address. Some optional features, such as remote access to the PIMA device or other devices on the LAN from external computers on the Internet, would require that the device have an external IP address (either statically or dynamically assigned by the ISP).

It will be apparent to those skilled in the art that various modification and variations can be made in the phone/Internet messaging appliance of the present invention without departing from the spirit or scope of the invention. Thus, it is intended that the present invention cover modifications and variations that come within the scope of the appended claims and their equivalents.

What is claimed is:

1. A communication device comprising:
a single external port for connecting to an analog telephone line of a circuit-switched network;
a broadband splitter circuitry connected to the single external port for separating the broadband and voice-band signals received from the external port and simultaneously outputting broadband signals on a broadband line and voice band signal on a voice band line;
analog voice/fax modem circuitry connected to the broadband splitter for receiving the voice band signal from the analog telephone line and for digitizing and recording voice and fax messages;
broadband modem circuitry connected to the broadband splitter for providing a high-speed connection to an external packet-switching network via the analog telephone line;
memory circuitry for storing digital data, including a non-volatile memory for storing firmware, settings and voice messages received from the analog telephone line; and
a control unit for controlling the operation of the communication device, the control unit programmed to automatically deliver both voice and fax messages received by the analog voice/fax modem to a designated location on the external packet-switching network using the broadband modem circuitry,
wherein the external port, the broadband splitter, the analog voice/fax modem circuitry, the broadband modem circuitry, the memory circuitry, and the control unit are integrated in a single housing.

2. The communication device of claim 1, further comprising:
a microphone for recording voice messages; and
a speaker for playing back voice messages received via the analog telephone line; and
a plurality of control keys for interfacing with a user to reconfigure the communication device,
wherein the microphone, the speaker and the control keys are provided on the housing of the communication device.

3. The communication device of claim 1, further comprising a telephone port for connecting to a telephone set.

4. The communication device of claim 1, further comprising a network interface for connecting to a local area network (LAN),
wherein the control unit is programmed to transmit data representing voice or fax messages via the network interface to the LAN to be stored or printed by an external device connected to the LAN.

5. The communication device of claim 1, further comprising a network interface for connecting to a local area network (LAN),
wherein the control unit is programmed to route data between the network interface and the external packet-switching network, whereby external devices connected on the LAN are connected to the external packet-switching network.

6. A method for authenticating a remote user communicating with a local device from a remote device via a primary communication channel, comprising:
receiving primary authentication information from the remote device via the primary communication channel;
verifying the primary authentication information;
if the primary authentication information is positively verified, transmitting a request for a dynamically generated secondary authentication response to a known alternative device associated with an authorized user via an alternative communication channel;
receiving a secondary authentication response via the primary communication channel;
verifying the secondary authentication response; and
granting access by the remote to the local device only if the secondary authentication response is positively verified.
